(19) United States
(12) Patent Application Publication
(10) Pub. No.: US 2006/0097472 A1
(43) Pub. Date: May 11, 2006

(54) Use of a bicycle transmission system

(76) Inventor: Jose P. Balajadia, New York, NY (US)

Correspondence Address: Jose P. Balajadia, 61-15 98th Street, Apt. 3J, Rego Park, Queens, NY, 11374, US

(21) Appl. No.: 10/973,604

(22) Filed: Oct. 26, 2004

(51) Int. Cl. B62M 9/04

(52) U.S. Cl. 280/210

(57) ABSTRACT

A tricycle (FIG. 4) is made by transforming Balajadia's bicycle (FIG. 3) into a tricycle. This was done by removing the rear wheel fork attached at the chain stay member and discarding it. In its place, the following were attached to the chain stay member under it: a 16 inch long, 1.25 inch diameter tube pipe was attached at the underside of the chain stay member at its middle. Then the break handles (BrH) were attached to both sides at the edge at a right angle, horizontally positioned and pointing to the rear. Next the two 2 inch pieces were attached one at each side to the end of the 11 inch tube pipe (BrH) at a right angle. An axle ¾ inch in diameter and 2 feet long was reduced at both ends to 7/16 inch in diameter, 3.5 inches long. ¾ inches long from the end was threaded oppositely, one clockwise and the other counterclockwise. A bicycle freewheel adapter was attached to the axle 2 inches from the center, then the bicycle freewheel was threaded on the bicycle freewheel adapter. Then the axle was inserted to a right bearing (B1) and then the free end was attached to the bearing holder (BH) 4 inches from the middle. Then a stopper (S1) was attached to the axle next to (B1). A second bearing (B2) was inserted to the left of the bicycle freewheel and the loose end was attached to the bearing holder (BH) at 4 inches from the center. Then a stopper (S2) was attached to the axle next to it (B2). The stopper prevents the axle from moving sideways by more than ⅛ of an inch. Then the two wheelchair wheels were inserted at both ends of the axle. The two nuts were threaded in to hold the wheelchair wheels in place tightly. A chain was placed so that the chainwheel and the bicycle freewheel are connected. The mode of operation of a tricycle with a bicycle transmission system in it is the same as in operating a bicycle.

### CROSS-REFERENCE TO THE RELATED APPLICATION

Application Ser. No. 10/637,916 dated Aug. 9, 2003.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention pertains to a new use of a bicycle transmission system in operating different vehicles on land, in water, in snow, and in the air.

There are three most relevant prior arts to this invention namely: (1) Balajadia's bicycle, U.S. Pat. No. 6,394,478 B1 dated May 28, 2002, (2) the two wheelchair wheels at the rear, (3) the bicycle freewheel and its adapter in application Ser. No. 10/637,916 dated Aug. 9, 2003.

(1) The bicycle has one front wheel and one rear wheel. It has its own bicycle transmission system comprising of a crank set, a bicycle freewheel, and a chain that connects the two. The bicycle is a popular vehicle of transportation but it is accident prone. Many riders have accidents with it. One has to prop oneself up with the feet to prevent falling when at the stop to avoid falling off the bicycle.

(2) The wheels of this invention are the wheels of a wheelchair. They are chosen because the wheels have a bearing inside and an opening where the axle can be inserted. The wheelchair rear wheel is 2 feet in diameter and has a central opening of ½ inch in diameter.

(3) The bicycle freewheel and its adapter may be found in application Ser. No. 10/637,916 dated Aug. 9, 2003.

It is the object of this invention to make a vehicle which would be stable and less prone to accidents than the bicycle. Also it is the object of the invention so that even those people who do not know how to ride a bicycle, young and old, may be able to use it.

### BRIEF SUMMARY OF THE INVENTION

A tricycle with its two rear wheels opposite each other is more stable and less accident prone than a bicycle which has only one rear wheel. One need not get off or prop oneself up to the ground to keep balance. The third wheel makes the vehicle easier and lighter to pedal than a bicycle. Concomitantly, the tricycle is faster than the bicycle.

One disadvantage of a tricycle is that it occupies more space than a bicycle because of the two rear wheels present.

### BRIEF DESCRIPTIONS OF THE SEVERAL VIEWS OF THE DRAWING

FIG. 1 is a side elevation and a perspective view of the bicycle freewheel, a prior art.

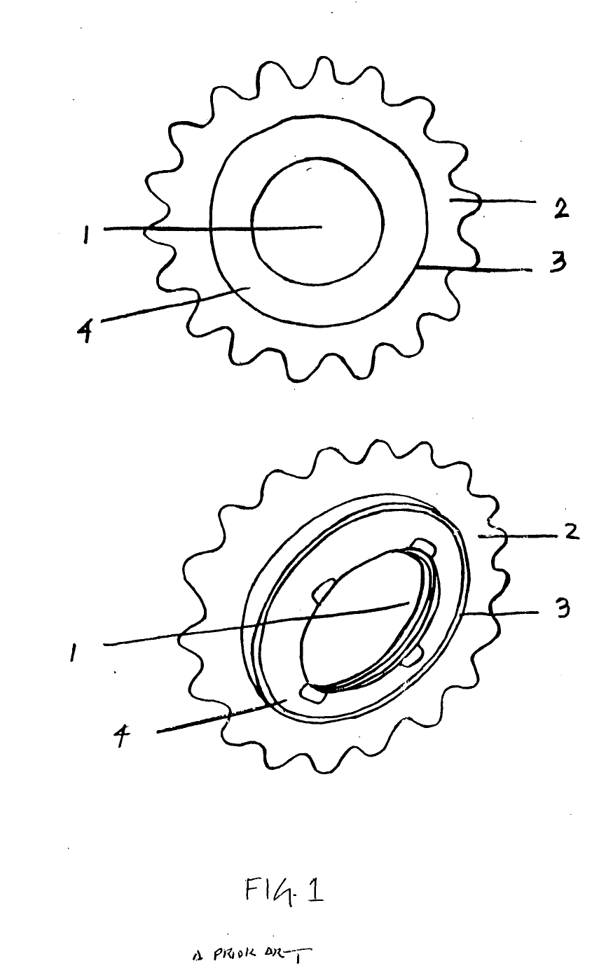

FIG. 2 is a perspective view of a bicycle freewheel adapter for an (A) axle and a (B) bottom bracket axle/spindle, a prior art.

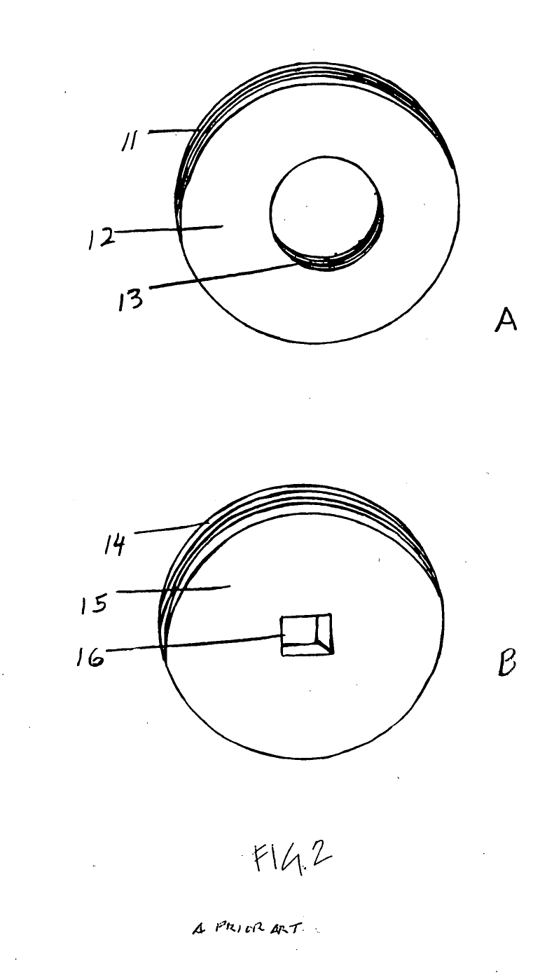

FIG. 3 is a side view of Balajadia's bicycle, a prior art.

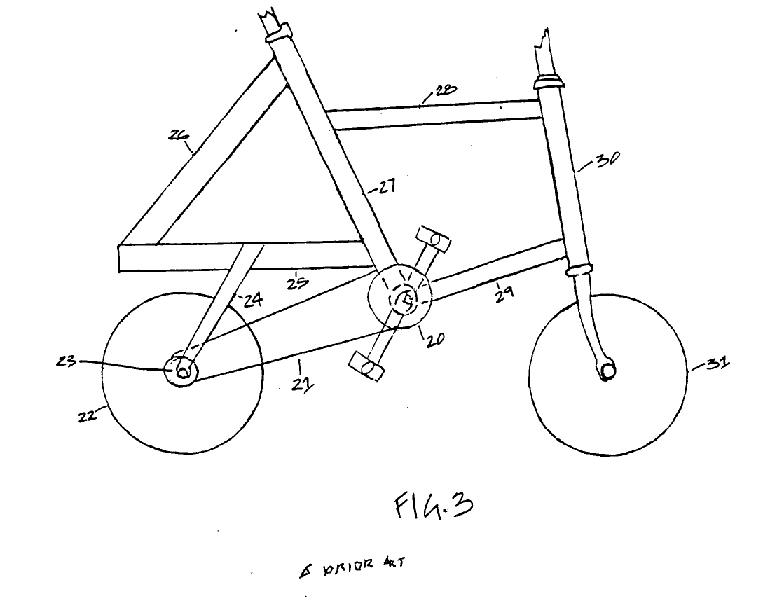

FIG. 4 is a perspective view of a tricycle with a bicycle transmission system in it.

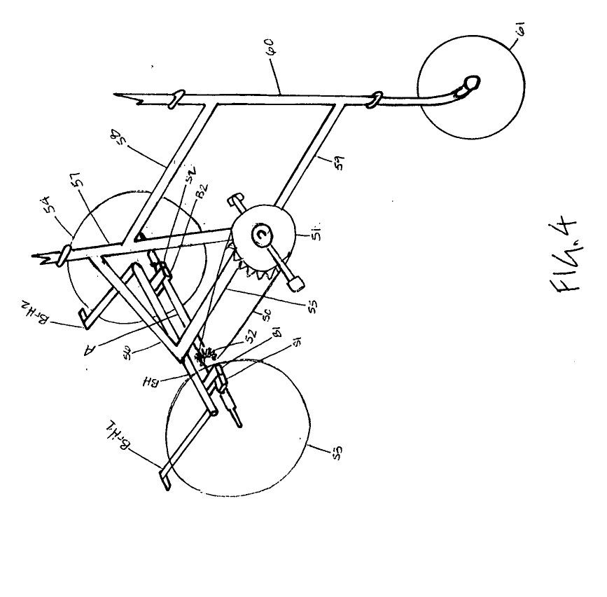

### DETAILED DESCRIPTION OF THE INVENTION

This invention is a new use of a bicycle transmission system in operating different vehicles such as on land, in water, in snow, and in the air. The vehicles on land have at least one front wheel and at least two rear wheels opposite each other. The wheels may be rotated by the use of an axle/shaft or bottom bracket axle/spindle with an extension within the wheels with means or without the wheels with means. At least one of the wheels may be rotated. The bicycle freewheel is attached to either the axle/shaft or bottom bracket axle/spindle. Examples are a wheelchair (foot or hand operated), a tricycle, a car, a cart, or a train and others. The vehicles in water are either afloat or submersible. The bicycle freewheel may be attached to an axle/shaft or a bottom bracket axle/spindle. The axle/shaft or the bottom bracket axle/spindle may be attached with one of the means such as a propeller or others for moving the vehicle. Examples are a canoe, a boat, a submarine and others. The vehicles in snow have means for sliding or maneuvering. The bicycle freewheel may be attached to an axle/shaft or bottom bracket axle/spindle. Examples are a ski, a sled, or others. The vehicles in the air have means for flying. The bicycle freewheel may be attached to an axle/shaft or a bottom bracket axle/spindle. The axle/shaft or bottom bracket axle/spindle may be attached with a means for rotating a rotor or a propeller or a combination thereof, or others. Examples are a helicopter, an airplane, a glider, and others.

There is only one preferred embodiment of this invention.

Making the tricycle prototype, a preferred embodiment: Although the tricycle may be made from scratch, to save time and money it would be better to just alter the rear frame of any existing bicycle. The wheel size at the rear may be retained or made different in size from the front wheel. Balajadia's bicycle U.S. Pat. No. 6,394,478 US dated May 28, 2002 is the ideal kind of bicycle to be used to make the tricycle because it only needs to remove the rear wheel fork. The rear wheel fork is removed and discarded together with the rear wheel leaving only the bicycle freewheel intact. The rear wheel is replaced with two wheelchair wheels, 2 feet in diameter. The other additions to the chain stay member are the following: 1. a ¾ inch diameter round solid metal to be used as axle, 2 feet long, 2. a 1 inch square by 6 inches long solid metal to be cut into 2 stoppers, (S1) and (S2) and bearings, (B1) and (B2), 3. one 1.25 inch diameter tube pipe, 16 inches long to be made into a bearing holder (BH) for the bearings and to attach the break handle (BrH), 4. an oval tube pipe ½ inch in diameter to be made into break handles (BrH) and attached to the bearing holder at a right angle, and at a horizontal position, 5. two wheelchair wheels, 24 inches in diameter without the metal railings, 6. two nuts of opposite threading to tighten the wheels. The ¾ inch diameter axle was reduced in diameter 3.5 inches from both ends to 7/16 diameter size. Of these ¾ inch from both ends was threaded oppositely one being clockwise and the other counterclockwise so that a nut can be threaded to tighten the wheel and prevent it from moving. The 1 inch square by 6 inches solid metal was cut into two 1 inch square by 1 inch as stoppers, (S1) and (S2) and two 1 inch square by 2 inches bearings, (B1) and (B2). All four were drilled on the side with a hole 13/16 inch in diameter. The oval tube pipe is cut into two 2 inches pieces and two 11 inches pieces to be used as handle for the breaks. The 1.25 inch diameter tube pipe is attached at its middle to the chain stay member underneath it. Then the bicycle freewheel adapter was welded 2 inches to the right of the axle from its middle to be in line with the chainwheel. The bicycle freewheel was then threaded onto the bicycle freewheel adapter. One of the bearings (B1) at the right side of the bicycle freewheel was inserted to the axle and the loose end which is the other end is welded onto the bearing holder, (BH) which is the 1.25 inch tube pipe, 4 inches from its middle. The other bearing (B2) was inserted to the axle and is to the left of the bicycle freewheel is attached to the bearing holder, (BH) at its end, 4 inches away from the middle. Next to the bearing, (B1) at its right, is attached to the axle the stopper (S1). Next to the bearing (B2), at its left, is attached to the axle, the stopper (S2). The 11 inch oval tube pipe on each side is attached by welding to the bearing holder (BH) at a right angle horizontally. The 2 inch piece is attached to the other end of the 11 inch piece at a right angle. This completes the break handle (BrH). Next, the two wheelchair wheels were inserted to both ends of the axle, then the two nuts were threaded in to tighten the wheels so that they won't be able to move. Lastly, a chain was placed over the chainwheel and the bicycle freewheel to connect them together. This completes the making of a tricycle converted from a bicycle.

The mode of operation of a tricycle with a bicycle transmission system in it is exactly like that of operating a bicycle.

Thus the reader will see the tricycle is more stable than a bicycle and is less prone to accidents. Millions of people regardless of age including young children, young adults, older people, and senior citizens can ride the tricycle even if they cannot ride a bicycle.

While my above description contains many specificities, these should not be construed as limitations on the scope of the invention, but rather as an exemplification of one preferred embodiment thereof. Many other variations thereof are possible. For example: For vehicles on land: 1. the wheels may run on the ground or on rails or tracks, 2. the two rear wheels may be the same or smaller or bigger than the front wheel, 3. aside from pushing the pedals providing a battery operated means or a fuel fed means may be used to rotate the bicycle freewheel, 4. the bicycle freewheel may have or not have a bicycle freewheel adapter, 5. a device with a gear may be used instead of a bicycle freewheel, 6. the device with a gear may be rotated by pushing the pedals or providing a battery operated means or a fuel fed means to rotate it, 7. the device with a gear operated by a ratchet and pawl may be rotated by pushing the pedals or providing a battery operated means or a fuel fed means. 8. the device with a gear operated by a ratchet and pawl may or may not require an adapter. For vehicles in water: 1. the bicycle freewheel may be rotated by providing a battery operated means or a fuel fed means to rotate it, 2. the axle/shaft or bottom bracket axle/spindle may have one or more means for moving the vehicle such as a propeller, bucket, paddle, and others or a combination thereof, 3. a device with a gear may be used instead of a bicycle freewheel by pushing the pedals or providing a battery operated means or a fuel fed means to rotate it, 4. a device with a gear operated by a ratchet and pawl may be used instead of a bicycle freewheel and may be rotated by pushing the pedals or providing a battery operated means or a fuel fed means to rotate it. 5. the device with a gear may or may not have an adapter required. For vehicles in snow: 1. one or more means for moving the vehicle may be attached to the axle/shaft or bottom bracket axle/spindle, 2. one or more or a combination may be in the vehicle, 3. a device with a gear may be used instead of a bicycle freewheel and may be rotated by pushing the pedals or providing a battery operated means or a fuel fed means to rotate it, 4. one or more means may be attached to the axle/shaft or bottom bracket axle/spindle, 5. a device with a gear operated by a ratchet and pawl may be used instead of a bicycle freewheel and may be rotated by pushing the pedals, providing a battery operated means or a fuel fed means to rotate it, 6. one or more means for moving the vehicle may be used or a combination thereof, 7. the bicycle freewheel may be rotated by providing a battery operated means or a fuel fed means. 8. the device with a gear may or may not require an adapter. For vehicles in the air: 1. the bicycle freewheel may be rotated by providing a battery operated means or a fuel fed means to rotate it, 2. a propeller or a rotor or a combination thereof may be used attached to the axle/shaft or bottom bracket axle/spindle with or without an attachment to extend it, 3. a device with a gear may be used instead of a bicycle freewheel and may be rotated by pushing the pedals, or providing a battery operated means or a fuel fed means to rotate it, 5. a device with a gear operated by a ratchet and pawl may be used instead of a bicycle freewheel and may be rotated by pushing the pedals or providing a battery operated means or a fuel fed means to rotate it, 6. a propeller or a rotor or a combination thereof may be used in the vehicle attached to the axle/shaft or bottom bracket axle/spindle with or without an attachment to extend it. 7. a device with a gear may or may not require an adapter.

Accordingly, the scope of the invention should be determined not by the embodiments illustrated but by the appended claims and the legal equivalents.

I claim:

1. A method of operating a bicycle transmission system in vehicles having at least one front wheel and at least two rear wheels opposite each other, comprising attaching the bicycle freewheel with means to an axle/shaft with means for rotating in place, said axle/shaft is rotating at least one of the rear wheels within with means or without with means, whereby pushing the pedals for rotating the bicycle freewheel and the axle/shaft together so that the vehicle moves forward.

2. The method of claim 1, wherein whereby providing a battery operated means or a fuel fed means for rotating the bicycle freewheel and the axle/shaft together so that the vehicle moves forward.

3. The method of claim 1, wherein attaching the bicycle freewheel with means to a bottom bracket axle/spindle with means for rotating in place, said bottom bracket axle/spindle with means is attaching with an axle/shaft rotating at least one of the rear wheels within with means or without with means.

4. The method of claim 3, wherein whereby providing a battery operated means or a fuel fed means for rotating the bicycle freewheel and the bottom bracket axle/spindle together so that the vehicle moves forward.

5. The method of claim 1, wherein attaching a device with a gear or a device with a gear operated by a ratchet and pawl with means to an axle/shaft with means for rotating in place, said axle/shaft is rotating at least one of the rear wheels within with means or without with means, whereby pushing the pedals for rotating the device with a gear or the device with a gear operated by a ratchet and pawl and the axle/shaft together so that the vehicle moves forward.

6. The method of claim 5, wherein whereby providing a battery operated means or a fuel fed means for rotating the device with a gear or the device with a gear operated by a ratchet and pawl and the axle/shaft together so that the vehicle moves forward.

7. The method of claim 3, wherein attaching a device with a gear or a device with a gear operated with a ratchet and pawl with means to a bottom bracket axle/spindle with means for rotating in place, said bottom bracket axle/spindle with means is attaching with an axle/shaft for rotating at least one of the rear wheels within with means or without with means, whereby pushing the pedals to rotate the device with a gear or the device with a gear operated by a ratchet and pawl and the bottom bracket axle/spindle together so that the vehicle moves forward.

8. The method of claim 7, wherein whereby providing a battery operated means or a fuel fed means for rotating the device with a gear or the device with a gear operated by a ratchet and pawl and the bottom bracket axle/spindle together so that the vehicle moves forward.

9. The method of claim 1, wherein attaching a bicycle freewheel or a device with a gear or a device with a gear operated by a ratchet and pawl with means to an axle/shaft with means for rotating in place, said axle/shaft is rotating at least one of the rear wheels running on rail or track within with means or without with means, whereby pushing the pedals or providing a battery operated means or a fuel fed means for rotating the bicycle freewheel, or a device with a gear or a device with a gear operated by a ratchet and pawl and the axle/shaft together so that the vehicle moves forward.

10. The method of claim 1, wherein attaching a bicycle freewheel or a device with a gear or a device with a gear operated by a ratchet and pawl with means to a bottom bracket axle/spindle with means for rotating in place, said bottom bracket axle/spindle with means is attaching with an axle/shaft for rotating at least one of the rear wheels running on rail or track, whereby pushing the pedals or providing a battery operated means or a fuel fed means for rotating the bicycle freewheel or the device with a gear or the device with a gear operated by a ratchet and pawl and the bottom bracket axle/spindle together so that the vehicle moves forward.

11. A method of operating a bicycle transmission system in a vehicle in water, afloat or submersible, comprising attaching a bicycle freewheel with means to an axle/shaft with means for rotating in place, said axle/shaft is attaching with at least one of the means such as a propeller and others for moving the vehicle, whereby pushing the pedals for rotating the bicycle freewheel and the axle/shaft together so that the vehicle moves forward.

12. The method of claim 11, wherein whereby providing a battery operated means or a fuel fed means to rotate the bicycle freewheel and the axle/shaft together so that the vehicle moves forward.

13. The method of claim 11, wherein attaching the bicycle freewheel with means such as a propeller and others, to a bottom bracket axle/spindle with means for rotating in place, said bottom bracket axle/spindle with means is attaching with at least one of the means for moving the vehicle forward.

14. The method of claim 13, wherein whereby providing a battery operated means or a fuel fed means for rotating the bicycle freewheel and the bottom bracket axle/spindle together so that the vehicle moves forward.

15. The method of claim 11, wherein attaching a device with a gear or a device with a gear operated by a ratchet and pawl with means to an axle/shaft with means for rotating in place, said axle/shaft with means is attaching with at least one of the means for moving the vehicle, such as a propeller or others for moving the vehicle, whereby pushing the pedals or providing a battery operated means or a fuel fed means for rotating the bicycle freewheel and the axle/shaft together so that the vehicle moves forward.

16. The method of claim 11, wherein attaching a device with a gear or a device with a gear operated by a ratchet and pawl with means to a bottom bracket axle/spindle with means for rotating in place, said bottom bracket axle/spindle with means is attaching with at least one of the means for moving the vehicle, such as a propeller or others for moving the vehicle, whereby pushing the pedals or providing a battery operated means or a fuel fed means for rotating the bicycle freewheel and the bottom bracket axle/spindle together so that the vehicle moves forward.

17. A method of operating a bicycle transmission system in a vehicle in snow with means for sliding and maneuvering, comprising attaching the bicycle freewheel with means to an axle/shaft with means for rotating in place, said axle/shaft with means is attaching with at least one of the means for moving the vehicle such as a propeller and others whereby pushing the pedals or providing a battery operated means or a fuel fed means for rotating the bicycle freewheel and the axle/shaft together so that the vehicle moves forward.

18. The method of claim 17, wherein attaching a bicycle freewheel with means to a bottom bracket axle/spindle with means for rotating in place, said bottom bracket axle/spindle with means is attaching with at least one of the means for moving the vehicle, such as a propeller or others for moving the vehicle, whereby pushing the pedals or providing a battery operated means or a fuel fed means for rotating the bicycle freewheel and the bottom bracket axle/spindle together so that the vehicle moves forward.

19. The method of claim 17, wherein attaching a device with a gear or a device with a gear operated by a ratchet and pawl with means to an axle/shaft with means for rotating in place, said axle/shaft with means is attaching with at least one of the means for moving the vehicle, such as a propeller or others for moving the vehicle, whereby pushing the pedals or providing a battery operated means or a fuel fed means for rotating the device with a gear or the device with a gear operated by a ratchet and pawl and the axle/shaft or bottom bracket axle/spindle together so that the vehicle moves forward.

20. The method of claim 19, wherein attaching a device with a gear or a device with a gear operated by a ratchet and pawl with means to a bottom bracket axle/spindle with means for rotating in place, said bottom bracket axle/spindle with means is attaching with at least one of the means for moving the vehicle, such as a propeller or others for moving the vehicle, whereby pushing the pedals or providing a battery operated means or a fuel fed means for rotating the device with a gear or the device with a gear operated by a ratchet and pawl and the bottom bracket axle/spindle together so that the vehicle moves forward.

21. A method of operating a bicycle transmission system in vehicles in the air with means to fly, comprising attaching the bicycle freewheel with means to an axle/shaft with means for rotating in place, said axle/shaft with means is attaching with at least one of the means such as a propeller or a rotor or a combination thereof, or others, whereby pushing the pedals or providing a battery operated means or a fuel fed means for rotating the bicycle freewheel and the axle/shaft together so that the vehicle soars.

22. The method of claim 21, wherein attaching a bicycle freewheel with means to a bottom bracket axle/spindle with means for rotating in place, said bottom bracket axle/spindle with means is attaching with at least one of the means for rotating a propeller or a rotor or a combination thereof, or others, whereby pushing the pedals or providing a battery operated means or a fuel fed means for rotating the bicycle freewheel and the bottom bracket axle/spindle together so that the vehicle soars.

23. The method of claim 21, wherein attaching a device with a gear or a device with a gear operated by a ratchet and pawl with means to an axle/shaft with means for rotating in place, said axle/shaft with means is attaching with at least one of the means for rotating a propeller or a rotor, or a combination thereof, or others, whereby pushing the pedals or providing a battery operated means or a fuel fed means for rotating the device with a gear or the device with a gear operated by a ratchet and pawl and the axle/shaft or bottom bracket axle/spindle together so that the vehicle soars.

24. The method of claim 23, wherein attaching a device with a gear or a device with a gear operated by a ratchet and pawl with means to a bottom bracket axle/spindle with means for rotating in place, said bottom bracket axle/spindle with means is attaching with at least one of the means for rotating a propeller or a rotor, or a combination thereof, or others, whereby pushing the pedals or providing a battery operated means or a fuel fed means for rotating the device with a gear or the device with a gear operated by a ratchet and pawl and the bottom bracket axle/spindle together so that the vehicle soars.
